(19) United States
(12) Patent Application Publication
(10) Pub. No.: US 2017/0069435 A1
(43) Pub. Date: Mar. 9, 2017

(54) Direct Current Energy Source and Electrical Consumer

(71) Applicant: Robert Bosch GmbH, Stuttgart (DE)

(72) Inventors: Elisabeth Buehler, Tamm (DE); Frederik Golks, Tuebingen (DE); Mathias Widmaier, Magstadt (DE); Pallavi Verma, Leinfelden (DE); Thomas Wagner, Leonberg (DE)

(21) Appl. No.: 15/254,238

(22) Filed: Sep. 1, 2016

(30) Foreign Application Priority Data
Sep. 4, 2015 (DE) 10 2015 216 973.1

(51) Int. Cl. H01G 11/74; H01G 11/78; H01G 11/46; H01G 11/08; H01G 11/04; H01G 11/68

(52) U.S. Cl. CPC H01G 11/74; H01G 11/04; H01G 11/68; H01G 11/46; H01G 11/08; H01G 11/78

(57) ABSTRACT

A direct current energy source includes a hybrid supercapacitor, a positive electrical contact element, and a negative electrical contact element. The positive electrical contact element and the negative electrical contact element are configured to electrically connect the direct current energy source simultaneously to an electrical consumer and to another similar direct current energy source.

This application claims priority under 35 U.S.C. §119 to patent application no. DE 102015216973.1 filed on Sep. 4, 2015 in Germany, the disclosure of which is incorporated herein by reference in its entirety.

The present disclosure relates to a direct current energy source. Furthermore, the present disclosure relates to an electrical consumer that is embodied so as to be supplied with electrical energy from the direct current energy source.

### BACKGROUND

Household devices having an energy consumption in excess of 1000 watt, such as by way of example hair dryers, irons and vacuum cleaners must be connected to a plug socket by means of a cable so as to be supplied with energy. This limits the spatial range of use for such devices since they can only be used where a plug socket is available. Whereas household devices can be provided with an unlimited amount of mobility as a result of being provided with batteries as a source of energy, this is not possible for the previously mentioned devices. Currently available batteries cannot provide the high electrical power that is required by such devices.

Hybrid supercapacitors—HSCs, such as by way of example lithium ion capacitors, represent a new generation of capacitors that can provide more power than lithium ion batteries. Although lithium ion batteries have at their disposal a high energy density of more than 100 Wh/kg, said batteries can however only release this energy slowly. Hybrid supercapacitors have at their disposal a higher energy density than high-energy supercapacitors (EDLCs/SCs), which although can make available more than 100 kW/kg, they do however only have at their disposal a small energy density. Hybrid supercapacitors can by way of example be charged by means of short high energy pulses as occur in the case of braking energy recuperation in motor vehicles. The electrical energy that is recuperated in this manner can be used as described hereinunder in order to accelerate the motor vehicle. This renders it possible to save on fuel and reduce carbon dioxide emissions. Hybrid supercapacitors are also considered for use as energy sources in electric tools. Since hybrid supercapacitors in comparison to other types of supercapacitors and batteries represent a new technology, there are currently only few products commercially available that use hybrid supercapacitors. In most cases, over-dimensioned lithium ion batteries are used in application areas that would be suitable for hybrid supercapacitors, said batteries being capable as a result of their size of making available energy in each case in the rate that is required for the relevant application.

Hybrid supercapacitors would be fundamentally suitable as energy sources for household devices that have high power requirements. However, there are currently no implementations of hybrid supercapacitors available that would render it possible for a consumer to use this as an energy source for household devices such as by way of example irons, vacuum cleaners or the like.

### SUMMARY

The direct current energy source in accordance with the disclosure comprises a hybrid supercapacitor, a positive electrical contact element and a negative electrical contact element.

The contact elements are embodied so as to electrically connect the direct current energy source simultaneously to an electrical consumer and to an another similar direct current energy source. This renders it possible to use multiple direct current energy sources that are connected in series so as to supply an electrical consumer with electrical energy. It is thus possible to design a single direct current energy source in such a manner that its dimensions are small and its weight low. If it is required that the electrical consumer has a long operating period, multiple direct current energy sources of this type can be thus connected to one another so as to render possible the required operating period and to achieve an increase in power.

By virtue of the fact that a hybrid supercapacitor is used as an energy storage device of the direct current energy sources, this energy source can be recharged. As a result of being able to connect multiple direct current energy sources to one another, said energy sources can be recharged simultaneously in one charging device.

In order to the able to attach the direct current energy source to the electrical consumer or to another direct current energy source in a simple manner, it is preferred that each contact element comprises a fastening region that is embodied so as to be connected in a mechanical manner to an electrical contact element of an electrical consumer and another similar direct current energy source. One design of the fastening region that is particular simple to handle is an adhesion area that is embodied so as to adhere to an electrical contact element of an electrical consumer and another similar direct current energy source. For this purpose, the adhesion region can comprise in particular a reversible, electrically conductive adhesive. However, it is fundamentally also possible that the fastening region is embodied by way of example as a hook, latch, clip or clamp connection.

In order to provide the direct current energy source with a high degree of mechanical flexibility, it is preferred that the hybrid supercapacitor comprises collectors that are embodied from a carbon fiber fabric. Such a direct current energy source can be used for different types of electrical consumers and comprises a high degree of robustness with respect to mechanical damage. This characteristic is important if the direct current energy source is to be handled by users who would possible not handle the sensitive energy source with the required amount of care.

At least one electrode of the hybrid supercapacitor comprises preferably at least one metal oxide that is dispersed on the carbon fiber fabric. This renders it possible to provide a fixed connection between the electrode and the collector that cannot be unintentionally detached even in the case of a mechanical deformation of the carbon fiber fabric or the electrode.

In order to be able to make sufficient electrical power available for electrical household devices, it is preferred that the direct current energy source comprises a hybrid supercapacitor that comprises an energy density in the region of at least 37.5 Wh/kg. The maximum energy density amounts preferably to 75.0 Wh/kg. In the case of this energy density, the hybrid supercapacitor comprises preferably a mass in the range of 100 g to 500 g. Consequently, a single direct current energy source can make available sufficient energy so as to supply a household device with electrical energy for a typical period of time of use. Simultaneously, however, the direct current energy source remains so light that it can be handled in a comfortable manner by a user.

In one embodiment of the disclosure, the hybrid supercapacitor is arranged in a pocket or pouch bag that comprises a first contact surface and a second contact surface. The two contact surfaces are electrical contact surfaces that are electrically isolated from one another. The first contact surface is connected to the positive electrical contact element and forms the first collector of the hybrid supercapacitor. The second contact surface is connected to the negative electrical contact element and forms the second collector of the hybrid supercapacitor. In this manner, it is not necessary to provide cabling between the collectors and separate electrical contact elements. On the contrary, the collectors are contacted directly by way of the contact surfaces. The hybrid supercapacitor is surrounded in the pocket by an electrical isolator. This can be embodied by way of example as a foil or as a synthetic material housing.

The electrical consumer comprises a first electrical contact element and a second electrical contact element. The first electrical contact element is embodied so as to make contact with the positive electrical contact element of the direct current energy source. The second electrical contact element is embodied so as to make contact with the negative electrical contact element of the direct current energy source. It is possible in this manner to supply the electrical consumer with electrical energy from the direct current energy source.

The electrical consumer is in particular an electrical consumer that has an input power of at least 1000 watt. Such electrical consumers can particularly profit from the fact that the direct current energy source can make available considerably more power than conventional batteries. Such electrical consumers can be by way of example vacuum cleaners, irons and hair dryers.

In one embodiment of the electrical consumer, said consumer comprises a receiving device that is embodied so as to receive multiple direct current energy sources. The positive electrical contact element of a first direct current energy source simultaneously makes contact with the first electrical contact element of the electrical consumer and the positive electrical contact element of a second direct current energy source. The negative electrical contact element of the first direct current energy source simultaneously makes contact with the second electrical contact element of the electrical consumer and the negative electrical contact element of the second direct current energy source. It is possible in this manner to supply the electrical consumer with electrical energy simultaneously from multiple direct current energy sources. The receiving device can be embodied in such a manner that the direct current energy sources are protected from damage or from being accidentally ripped off. This is particularly simple to achieve in the case of electrical consumers having a large internal installation space, such by way of example vacuum cleaners. In contrast, in another embodiment of the electrical consumer, a receiving device is omitted. The two electrical contact elements of the electrical consumer are attached to the surface of said consumer in this embodiment so that one or multiple direct current energy sources can be fastened to the electrical contact elements and can supply said consumer with electrical energy. In this case they hang down outside the electrical consumer. This embodiment is particularly advantageous in the case of electrical consumers that do not comprise sufficient internal installation space for receiving the direct current energy source. This can be in this case by way of example a hair dryer or iron.

### BRIEF DESCRIPTION OF THE DRAWINGS

Exemplary embodiments of the disclosure are illustrated in the drawings and further explained in the description hereinunder.

FIG. 1 illustrates schematically a hybrid supercapacitor that is arranged in an exemplary embodiment of the direct current energy source in accordance with the disclosure.

FIG. 2 illustrates schematically a direct current energy source in accordance with an exemplary embodiment of the disclosure.

FIG. 3 illustrates schematically how in one exemplary embodiment of the disclosure two direct current energy sources in accordance with FIG. 2 are connected to an electrical consumer.

### DETAILED DESCRIPTION

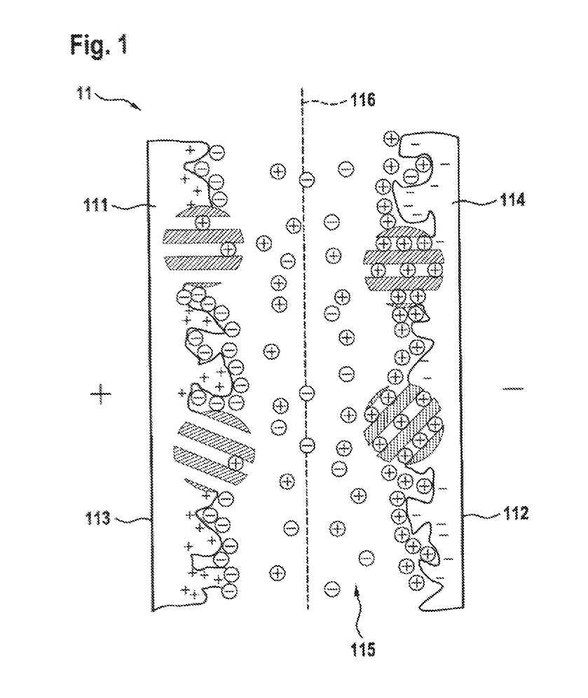

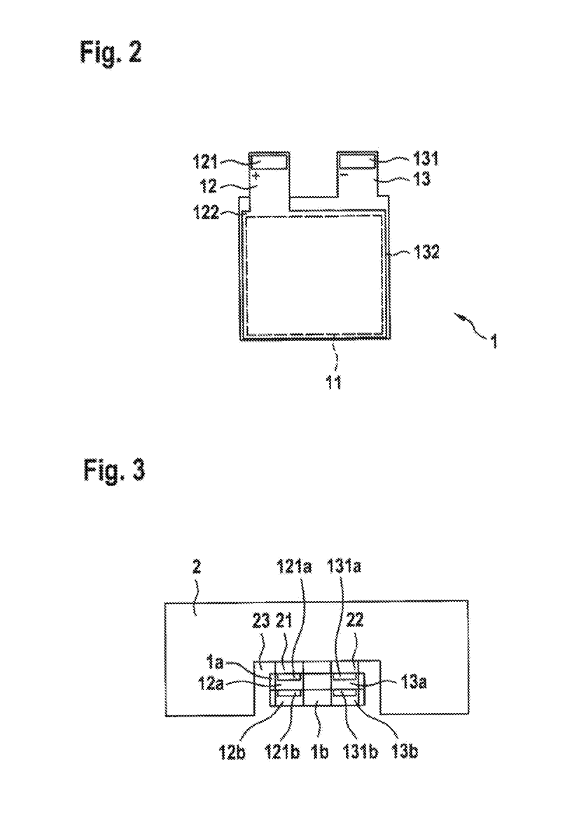

In one exemplary embodiment of the direct current energy source in accordance with the disclosure, a hybrid supercapacitor 11 is arranged that is illustrated schematically in FIG. 1. This hybrid supercapacitor 11 comprises two collectors 111, 112 that are embodied in each case from a textile fabric comprising carbon fibers. A cathode 113 comprising LiMn₂O₄ particles is dispersed on the first collector 111. An anode 114 comprises Li₄Ti₅O₁₂ particles is dispersed on the second collector 112. H₄[W₁₂SiO₄₀] (wolfram silicic acid; SiWA) is condensed to form a polymer electrolyte 115 that is arranged between the cathode 113 and the anode 114. Furthermore, a separator 116 of porous polytetrafluorethylene is used to separate the cathode 113 from the anode 114. The figure illustrates schematically in four enlargements (striped circles) Li* ions embedded in the cathode 113 and in the anode 114. This hybrid supercapacitor comprises an energy density of 50 Wh/kg.

The direct current energy source 1 is embodied as a pocket that holds the hybrid supercapacitor 11. A positive electrical contact element 12 and a negative electrical contact element 13 are used to draw current from the direct current energy source 1. The positive electrical contact element 12 is welded to a first electrical contact surface 122 that forms the first collector 111, and the negative electrical contact element 13 is welded to a second electrical contact surface 132 that forms the second collector 112. The two electrical contact surfaces 122, 132 are surrounded by an electrical isolator (not illustrated) of the pocket that encompasses the hybrid supercapacitor 11. The electrical isolator is embodied as an aluminum foil that is coated with polyurethane. The electrical contact elements 12, 13 and the contact surfaces 122, 132 comprise in each case a metal foil for conducting electrical energy. A reversible, electrically conductive adhesive is applied on one face of the electrical contact elements 12, 13 in each case in a fastening region 121, 131.

The electrical consumer in a first exemplary embodiment is a vacuum cleaner having an input power of 1800 W and a current strength of 10 A. For this vacuum cleaner, a direct current energy source 1 in accordance with its above mentioned exemplary embodiment is provided and the hybrid supercapacitor 11 of said direct current energy source has a mass of 0.18 kg. This stores an electrical energy of 9 Wh, which in the case of a voltage of 2.5 V corresponds to a charge of 3.6 Ah. It is hereby possible to supply the vacuum cleaner for 0.36 hours, in other words approx. 20 minutes, with a current strength of 10 A. Multiple direct current energy sources 1 can be connected to the vacuum cleaner for a longer operation of the vacuum cleaner. This illustrated schematically in FIG. 3. The electrical consumer 2 comprises two electrical contact elements 21, 22 that are arranged in a receiving device 23 in the vacuum cleaner housing. A first direct current energy source 1a is arranged in the receiving device 23 in such a manner that its positive electrical contact element 12a is arranged with its fastening region 121a on the first electrical contact element 21 and its negative electrical contact element 13a is arranged with its fastening region 131a on the second electrical contact element 22. A second direct current energy source 1b is arranged on the first direct current energy source 1a in such a manner that the positive electrical contact element 12b of the second direct current energy source 1b adheres with its fastening region 121b on the positive electrical contact element 12a of the first direct current energy source 1a. The negative electrical contact element 13b of the second direct current energy source 1b adheres with its fastening region 131b on the negative electrical contact element 13b of the first direct current energy source 1a. The two direct current energy sources 1a, 1b are protected in the receiving device 23 from damage, contamination and being accidentally torn off. For this purpose, the receiving device 23 can be closed by a cover, not illustrated.

In a second exemplary embodiment, not further illustrated, of the electrical consumer 2, the electrical consumer is embodied as an iron having an input power of 2900 W and a current strength of 12 A. In order to supply this iron with electrical energy, a direct current energy source 1 is provided in accordance with the above exemplary embodiment, said direct current energy source comprising a hybrid supercapacitor 11 having a mass of 0.29 kg. This stores an energy of 14.5 Wh that in the case of a voltage of 2.5 V corresponds to a charge of 5.8 Ah. It can make available a current strength of 12 A for 0.48 hours, in other words for approx. half an hour. The electrical contact elements 21, 22 of the iron are not arranged in its interior but rather outside on the handle of the iron. Although the housing of the iron does not comprise sufficient space for receiving the direct current energy source and this would also be exposed therein to very high temperatures, the electrical contacts that are arranged on the handle render it possible to fasten the direct current energy source 1 on the iron, in that it hangs down from the handle.

In a third exemplary embodiment, not further illustrated, of the electrical consumer, the electrical consumer is embodied as a hair dryer. This comprises an input power of 2000 W and a current strength of 8.3 A. In order to supply said electrical consumer, a direct current energy source 1 is provided in accordance with its exemplary embodiment and the hybrid supercapacitor 11 of said direct current energy source comprises a mass of 0.20 kg. This stores energy of 10 Wh that in the case of a voltage of 2.5 V corresponds to a charge of 4 Ah. As a consequence, it can make available an electrical current of 8.3 A for 0.48 hours, in other words for approx. half an hour. The hair dryer also comprises electrical contact elements 21, 22 that are arranged on its outer face so that the direct current energy source 1 hangs down from it. As a result, this is protected from the high temperature that occurs in the hair dryer and despite the small housing of the hair dryer can be fastened to said hair dryer.

What is claimed is:

1. A direct current energy source, comprising:
a hybrid supercapacitor;
a positive electrical contact element; and
a negative electrical contact element,
wherein the positive electrical contact element and the negative electrical contact element are configured to electrically connect the direct current energy source simultaneously to an electrical consumer and to another similar direct current energy source.

2. The direct current energy source of claim 1, wherein each of the positive electrical contact element and the negative electrical contact element includes:
a fastening region configured to mechanically connect to at least one of: (i) the electrical contact element of the electrical consumer and (ii) the another similar direct current energy source.

3. The direct current energy source of claim 2, wherein the fastening region is an adhesion region that has an electrically conductive reversible adhesive.

4. The direct current energy source of claim 1, wherein the hybrid supercapacitor includes collectors that are embodied from a carbon fiber fabric.

5. The direct current energy source of claim 4, wherein at least one electrode of the hybrid supercapacitor includes at least one metal oxide dispersed on the carbon fiber fabric.

6. The direct current energy source of claim 1, wherein the hybrid supercapacitor includes an energy density in the range of 37.5 to 75.0 Wh/kg.

7. The direct current energy source of claim 6, wherein the hybrid supercapacitor includes a mass in the range of 100 g to 500 g.

8. The direct current energy source of claim 1, wherein the hybrid supercapacitor is arranged in a pocket, the pocket having a first electrical contact surface and a second electrical contact surface,
wherein the first contact surface is connected to the positive electrical contact element and is formed by a first collector of the hybrid supercapacitor,
wherein the second contact surface is connected to the negative electrical contact element and is formed by a second collector of the hybrid supercapacitor, and
wherein the hybrid supercapacitor is surrounded by an electrical isolator.

9. An electrical consumer comprising:
a first electrical contact element configured to make contact with a positive electrical contact element of a direct current energy source; and
a second electrical contact element configured to make contact a negative electrical contact element of the direct current energy source,
wherein the direct current energy source includes:
a hybrid supercapacitor;
a positive electrical contact element; and
a negative electrical contact element,
wherein the positive electrical contact element and the negative electrical contact element are configured to electrically connect the direct current energy source simultaneously to an electrical consumer and to another similar direct current energy source.

10. The electrical consumer of claim 9, further comprising:
a receiving device configured to receive multiple direct current energy sources in such a manner that:
(i) the positive electrical contact element of a first direct current energy source simultaneously makes contact with the first electrical contact element of the electrical consumer and the positive electrical contact element of a second direct current energy source and
(ii) the negative electrical contact element of the first direct current energy source simultaneously makes contact with the second electrical contact element of the electrical consumer and the negative electrical contact element of the second direct current energy source.

11. The electrical consumer of claim 9, further comprising an input power of at least 1000 Watt.

12. The electrical consumer of claim 11, wherein the electrical consumer is a vacuum cleaner, an iron or a hair dryer.
